(19) United States
(12) Patent Application Publication
(10) Pub. No.: US 2019/0147357 A1
(43) Pub. Date: May 16, 2019

(54) AUTOMATIC DETECTION OF LEARNING MODEL DRIFT

(71) Applicant: Red Hat, Inc., Raleigh, NC (US)

(72) Inventors: Erik J. Erlandson, Phoenix, AZ (US); William C. Benton, Madison, WI (US)

(21) Appl. No.: 15/814,825

(22) Filed: Nov. 16, 2017

(51) Int. Cl. G06N 7/00; G06F 15/18; G06F 17/18; G06N 3/08

(52) U.S. Cl. CPC G06N 7/005; G06N 3/08; G06F 17/18; G06F 15/18

(57) ABSTRACT

Automatic detection of learning model drift is disclosed. A sidecar learning model receives operational input data submitted to a predictive learning model. The sidecar learning model was trained on a same training data used to train the predictive learning model. A deviation of the operational input data from the training data is determined. The sidecar learning model generates a drift signal that characterizes the deviation of the operational input data from the training data.

### TECHNICAL FIELD

The examples relate generally to learning models, and in particular to automatically detecting learning model drift.

### BACKGROUND

Machine learning models, such as neural networks, Bayesian networks, and Gaussian mixture models, for example, are often utilized to make predictions based on current operational data. The accuracy of a prediction by a machine learning model is in part based on the similarity of the current operational data to the training data on which the machine learning model was trained.

### SUMMARY

The examples relate to the automatic detection of learning model drift. A learning model receives operational data and makes predictions based on the operational data. Learning model drift relates to differences between operational data and deviation of such operational data over time from the training data on which the learning model was originally trained. As learning model drift increases, accuracy of predictions by the learning model decreases.

The examples utilize a sidecar learning model that is trained using the same data that is used to train a learning model. Operational data that is fed to the learning model in order to obtain predictions from the learning model is also fed to the sidecar learning model. The sidecar learning model outputs a drift signal that characterizes the deviation of the operational data from the training data.

In one example a method is provided. The method includes receiving, by a sidecar learning model, operational input data submitted to a predictive learning model, the sidecar learning model trained on a same training data used to train the predictive learning model. The method further includes determining a deviation of the operational input data from the training data and includes generating, by the sidecar learning model, a drift signal that characterizes the deviation of the operational input data from the training data.

In another example a computing device is provided. The computing device includes a memory, and a processor device coupled to the memory. The processor device is to receive, by a sidecar learning model, operational input data submitted to a predictive learning model, the sidecar learning model trained on a same training data used to train the predictive learning model. The processor device is further to determine a deviation of the operational input data from the training data. The processor device is further to generate, by the sidecar learning model, a drift signal that characterizes the deviation of the operational input data from the training data.

In another example a computer program product stored on a non-transitory computer-readable storage medium is provided. The computer program product includes instructions to cause a processor device to receive, by a sidecar learning model, operational input data submitted to a predictive learning model, the sidecar learning model trained on a same training data used to train the predictive learning model. The instructions further cause the processor device to determine a deviation of the operational input data from the training data and to generate, by the sidecar learning model, a drift signal that characterizes the deviation of the operational input data from the training data.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a training environment in which examples may be practiced;

FIG. 2 is a block diagram of an operational environment in which additional aspects of the examples may be practiced;

FIG. 3A is a block diagram of an operational environment that illustrates a real-time graph that depicts a deviation of operational input data from training data according to one example;

FIG. 3B is a block diagram of an operational environment that illustrates a presentation of a confidence level of a predictive learning model based on a deviation of operational input data from training data according to one example;

FIG. 3C is a block diagram of an operational environment that illustrates a presentation of an alert based on a determination that the operational input data deviates from the training data by a predetermined criteria according to one example;

FIG. 4 is a flowchart of a method for generating a drift signal according to one example;

FIG. 5 is a flowchart of a method for generating a signal for presentation that characterizes a deviation of operational input data from training data according to one example;

FIG. 6 is a simplified block diagram of the operational environment illustrated in FIG. 2 according to one example; and

FIG. 7 is a block diagram of a computing device suitable for implementing examples disclosed herein according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. As used herein and in the claims, the articles “a” and “an” in reference to an element refers to “one or more” of the element unless otherwise explicitly specified.

Machine learning models (hereinafter “predictive learning models”), such as neural networks, Bayesian networks, and random forests, for example, are often utilized to make predictions based on current operational data. The accuracy of a prediction by a predictive learning model is in part based on the similarity of the current operational data and the training data on which the predictive learning model was trained.

A predictive learning model is trained on a training data set that represents a particular snapshot in time of an ongoing data stream. After the predictive learning model is trained and deployed in operation, the data stream, referred to herein as operational data, will often continue to evolve. When the operational data changes sufficiently relative to the original training data set, the predictive performance (aka “inference”) of the predictive learning model degrades because the operational data is from regions of the larger feature space that the predictive learning model never encountered through the training data set. This phenomenon is sometimes referred to as “learning model drift,” although in fact it is the operational data, not the predictive learning model, that is drifting.

Detecting learning model drift directly by comparing the output of the predictive learning model against ground truth is almost always impossible, because no such ground truth exists for the operational data. Because operational data that has drifted from the training data degrades the performance of the predictive learning model, and therefore erodes the business value of the predictive learning model in operation, it is desirable to detect the drift of the operational data as it occurs. Detecting the drift of the operational data may be useful, for example, to determine when a predictive learning model should be retrained on current operational data.

The examples relate to the automatic detection of learning model drift. The examples utilize a sidecar learning model that is trained using the same data that is used to train a learning model. Operational data that is fed to the learning model in order to obtain predictions from the learning model is also fed to the sidecar learning model. The sidecar learning model outputs a drift signal that characterizes the deviation of the operational data from the training data. Based on the drift signal, any number of actions may be taken, including, by way of non-limiting example, retraining the learning model with current operational data.

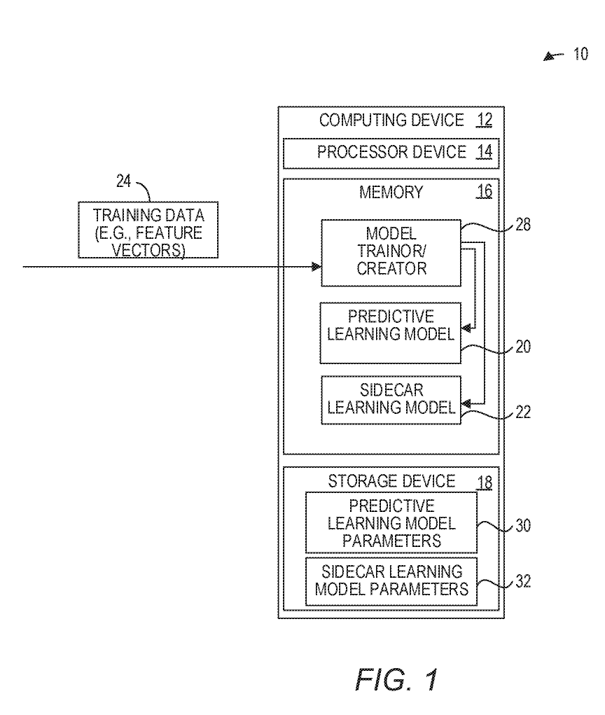

FIG. 1 is a block diagram of a training environment 10 in which certain aspects of the examples may be practiced according to one example.

The training environment 10 includes a computing device 12 that has a processor device 14 and a memory 16. The computing device 12 also has, or is communicatively connected to, a storage device 18.

The memory 16 includes a predictive learning model 20. The predictive learning model 20 may comprise any type of learning model, such as, by way of non-limiting example, a neural network, a random forest, a support vector machine, or the like. The memory 16 also includes a sidecar learning model 22. The sidecar learning model 22 may comprise any type of learning model that is capable of modeling a joint distribution of features in a set of training data 24. In some examples, the sidecar learning model 22 is a Gaussian mixture model (GMM). In other examples, the sidecar learning model 22 may comprise, by way of non-limiting example, a self-organizing map, an auto-encoding neural network, a Mahalanobis-Taguchi system, a linear model, a decision tree model, a tree ensemble model, or the like.

In some examples, a model trainor/creator 28 may automatically generate the sidecar learning model 22 in response to an input. For example, upon receiving a definition of the predictive learning model 20, the model trainor/creator 28 may generate not only the predictive learning model 20, but also the sidecar learning model 22.

In one example, the model trainor/creator 28 receives the training data 24. The training data 24 comprises feature vectors, which collectively form a training dataset. The model trainor/creator 28, based on the training data 24, generates the predictive learning model 20. The model trainor/creator 28 also, based on the training data 24, generates the sidecar learning model 22. Note that the predictive learning model 20 and the sidecar learning model 22 may be the same type of learning model or may be different types of learning models. In some examples, the predictive learning model 20 may be a supervised model, such as a random forest model, predictive neural net model, support vector machine model, logistic regression model, or the like. In some examples, the sidecar learning model 22 may be an unsupervised model, such as a clustering model, a self-organizing map (SOM) model, an autoencoder model, a GMM, or the like. While for purposes of simplicity only a single model trainor/creator 28 is illustrated, in some examples two model trainor/creators 28 may be utilized, one to create the predictive learning model 20, and one to create the sidecar learning model 22.

The predictive learning model 20 fits predictive learning model parameters 30 to the training data 24. The sidecar learning model 22 fits sidecar learning model parameters 32 to the training data 24. While for purposes of illustration the predictive learning model parameters 30 and the sidecar learning model parameters 32 are illustrated as being separate from the predictive learning model 20 and the sidecar learning model 22, respectively, it will be appreciated that the predictive learning model parameters 30 are integral with the predictive learning model 20, and the sidecar learning model parameters 32 are integral with the sidecar learning model 22.

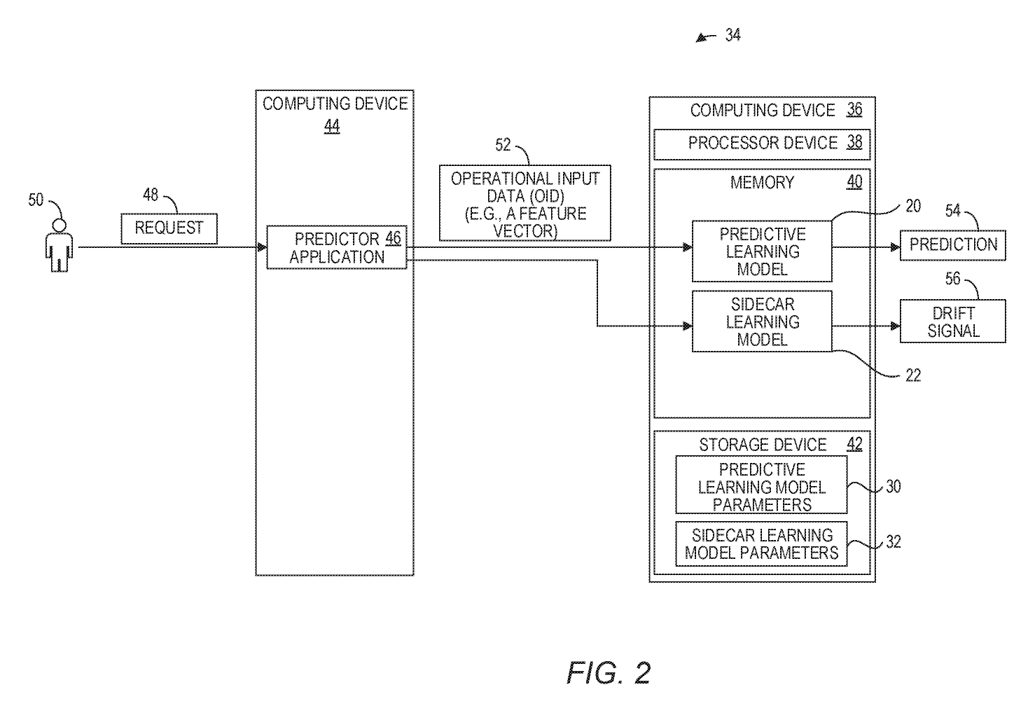

FIG. 2 is a block diagram of an operational environment 34 in which additional aspects of the examples may be practiced. The operational environment 34 includes a computing device 36 that has a processor device 38 and a memory 40. The computing device 36 also has, or is communicatively connected to, a storage device 42. The memory 40 includes the predictive learning model 20 and the sidecar learning model 22 trained in FIG. 1, as well as the predictive learning model parameters 30 and the sidecar learning model parameters 32 generated, respectively, by the predictive learning model 20 and the sidecar learning model 22 trained in FIG. 1.

The operational environment 34 also includes a computing device 44 that includes a predictor application 46. The predictor application 46 receives a request 48 from a user 50. Based on the request 48, the predictor application 46 generates operational input data (OID) 52 that comprises, for example, a feature vector, and supplies the OID 52 to the predictive learning model 20. The predictive learning model 20 receives the OID 52 and outputs a prediction 54. The prediction 54 is based on the predictive learning model parameters 30 generated during the training stage described above with regard to FIG. 1 and is based on the OID 52. The prediction 54, for example, may be presented to the user 50. Note that the predictive learning model 20 does not further learn (e.g., train) based on the OID 52.

The predictor application 46 also sends the OID 52 to the sidecar learning model 22. The sidecar learning model 22 receives the OID 52 that was submitted to the predictive learning model 20 and determines a deviation of the OID 52 from the training data 24 (FIG. 1). The sidecar learning model 22 generates a drift signal 56 that characterizes the deviation of the OID 52 from the training data 24.

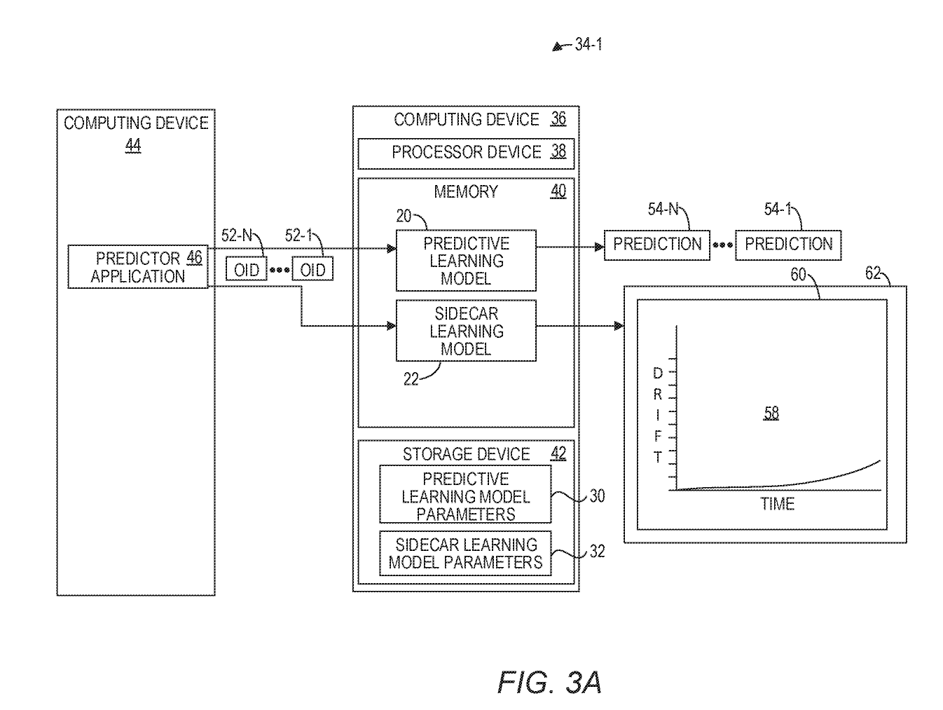

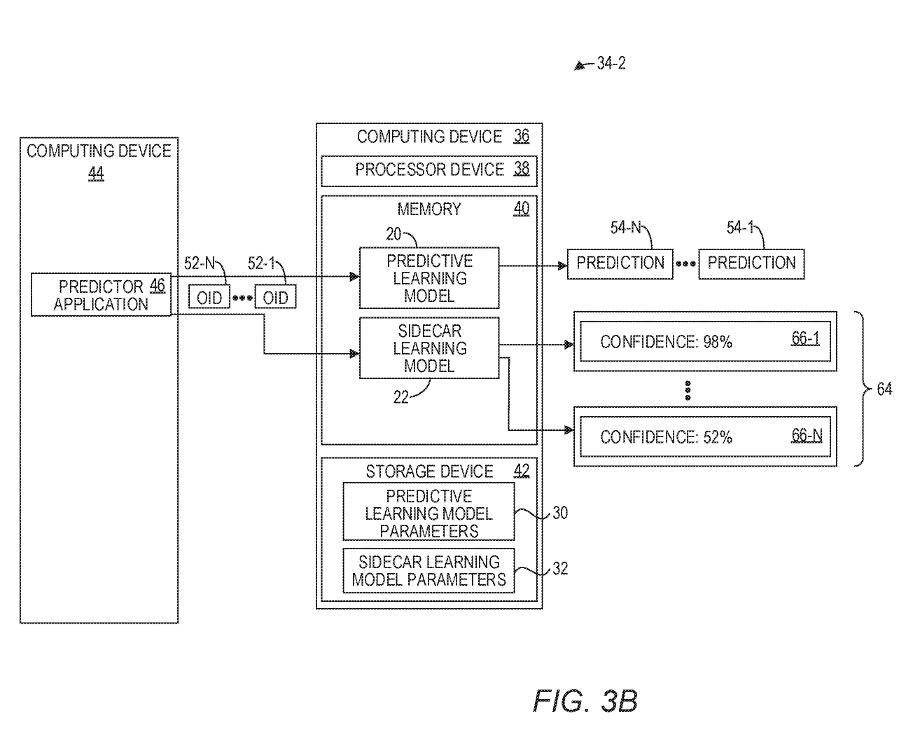

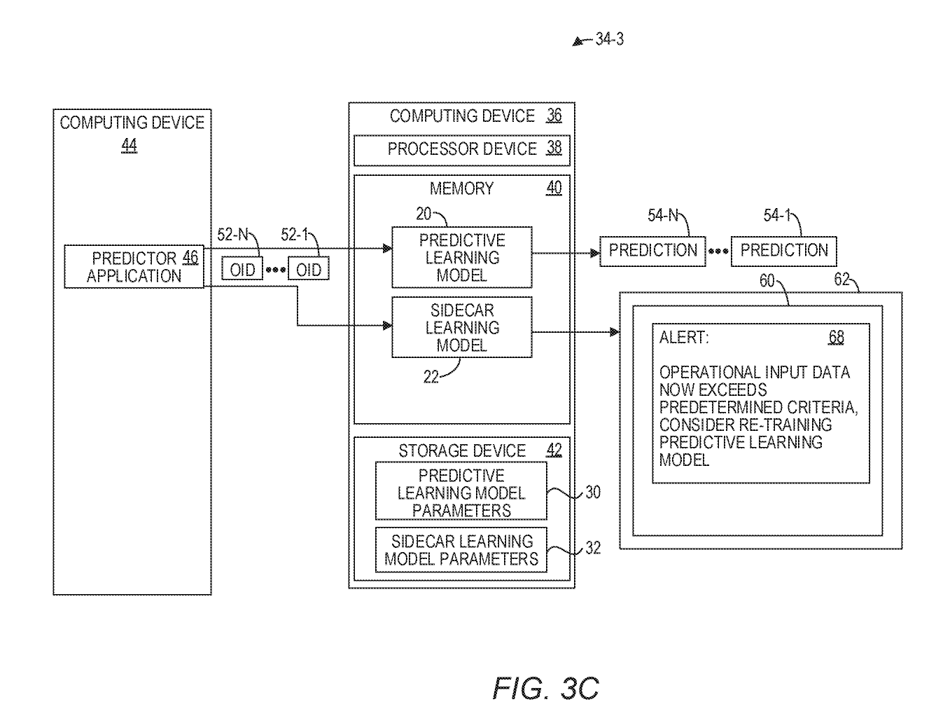

FIG. 3A is a block diagram of an operational environment 34-1 that illustrates a real-time graph 58 that depicts a deviation of operational input data from the training data 24 according to one example. The operational environment 34-1 is substantially similar to the operational environment 34 except as otherwise as noted herein. Over a period of time the user 50 submits a plurality of requests 48 (FIG. 2) to the predictor application 46. Based on the plurality of requests 48, the predictor application 46 generates a corresponding plurality of occurrences of OIDs 52-1-52-N, each OID 52-1-52-N corresponding to one of the requests 48. The OIDs 52-1-52-N comprise feature vectors. The OIDs 52-1-52-N are provided to the predictive learning model 20 over the period of time. The predictive learning model 20 receives the OIDs 52-1-52-N, and issues corresponding predictions 54-1-54-N based on the OIDs 52-1-52-N and the predictive learning model parameters 30.

The predictor application 46 also sends the OIDs 52-1-52-N to the sidecar learning model 22. The sidecar learning model 22 determines the deviation of the operational input data 52 from the training data 24 by comparing the joint distribution of the training data 24 to the OID 52. The sidecar learning model 22 may use any desirable algorithm for determining the deviation between the two distributions, including, by way of non-limiting example, a Kullback-Leibler divergence mechanism. The sidecar learning model 22 generates the drift signal 56, which in this example includes presenting in a user interface 60 of a display device 62 the real-time graph 58 that depicts the deviation of the OID 52 from the training data 24. The display device 62 may be positioned near an operator, for example, who may view the real-time graph 58 and determine at some point in time that it is time to retrain the predictive learning model 20, or take some other action.

FIG. 3B is a block diagram of an operational environment 34-2 that illustrates the presentation of a confidence level of the predictive learning model 20 based on the deviation of the operational input data 52 from the training data 24. The operational environment 34-2 is substantially similar to the operational environments 34, 34-1 except as otherwise noted herein. Over a period of time, the user 50 submits the plurality of requests 48 (FIG. 2) to the predictor application 46. Based on the plurality of requests 48, the predictor application 46 generates the corresponding plurality of occurrences of OIDs 52-1-52-N, each OID 52-1-52-N corresponding to one of the requests 48. The OIDs 52-1-52-N are provided to the predictive learning model 20 over the period of time. The predictive learning model 20 receives the OIDs 52-1-52-N, and issues corresponding predictions 54-1-54-N.

The predictor application 46 also sends the OIDs 52-1-52-N to the sidecar learning model 22. The sidecar learning model 22 determines the deviation of the OID 52 from the training data 24 by comparing the joint distribution of the training data 24 to the operational input data 52. The sidecar learning model 22 generates the drift signal 56 and, based on the drift signal 56, generates a confidence signal 64 that identifies a confidence level of the predictive learning model 20 to the OIDs 52-1-52-N. In this example, the confidence signal 64 comprises a plurality of confidence levels 66-1-66-N that correspond to the OIDs 52-1-52-N, and that identify a confidence level of the predictions 54-1-54-N issued by the predictive learning model 20.

Again, the display device 62 may be positioned near an operator, for example, who may view the confidence signal 64 and determine at some point in time that it is time to retrain the predictive learning model 20, or take some other action.

FIG. 3C is a block diagram of an operational environment 34-3 that illustrates the presentation of an alert based on a determination that the OID 52 deviates from the training data 24 by a predetermined criterion according to one example. The operational environment 34-3 is substantially similar to the operational environments 34, 34-1, 34-2 except as otherwise noted herein. Over a period of time, the user 50 submits the plurality of requests 48 (FIG. 1) to the predictor application 46. Based on the plurality of requests 48, the predictor application 46 generates the corresponding plurality of occurrences of OIDs 52-1-52-N, each OID 52-1-52-N corresponding to one of the requests 48. The OIDs 52-1-52-N are provided to the predictive learning model 20 over the period of time. The predictive learning model 20 receives the OIDs 52-1-52-N, and issues corresponding predictions 54-1-54-N.

The predictor application 46 also sends the OIDs 52-1-52-N to the sidecar learning model 22. The sidecar learning model 22 determines the deviation of the OID 52 from the training data 24 by comparing the joint distribution of the training data 24 to the OID 52. The sidecar learning model 22 generates the drift signal 56, and, based on the drift signal 56, generates an alert 68 for presentation on the display device 62 that indicates that the OID 52 deviates from the training data 24 by a predetermined criterion. As an example of a predetermined criterion, in some examples the drift signal 56 identifies a probability that the OID 52 is from a different distribution than the training data 24, and the predetermined criterion may be a probability threshold value, such as 95%, that identifies the particular threshold probability above which the alert 68 should be generated. Again, the display device 62 may be positioned near an operator, for example, who may view the alert 68 and determine, based on the alert 68, that it is time to retrain the predictive learning model 20, or take some other action.

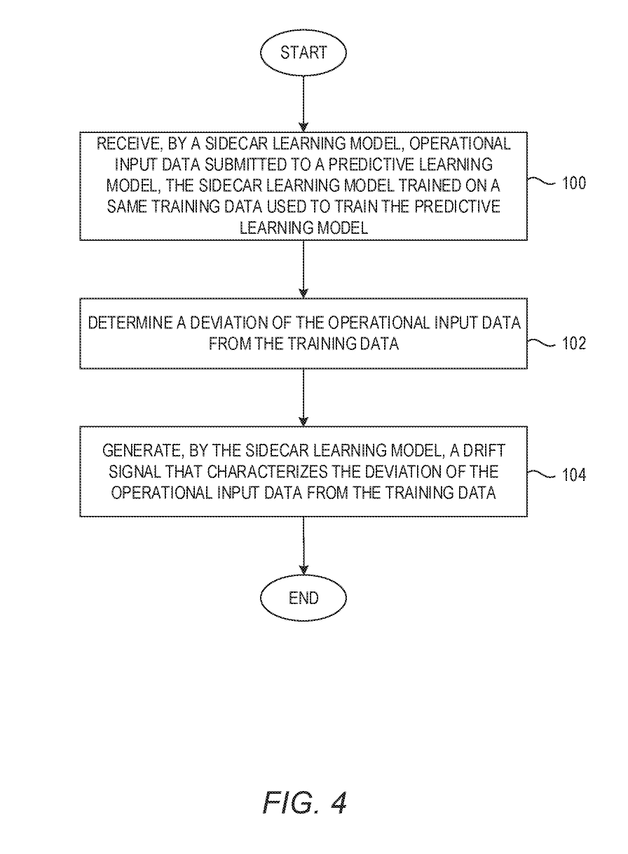

FIG. 4 is a flowchart of a method for generating a drift signal according to one example. FIG. 4 will be discussed in conjunction with FIGS. 1 and 2. The sidecar learning model 22 receives the OID 52 that is submitted to the predictive learning model 20, the sidecar learning model 22 being trained on the same training data 24 used to train the predictive learning model 20 (FIG. 4, block 100). The sidecar learning model 22 determines a deviation of the OID 52 from the training data 24, and generates the drift signal 56 that characterizes the deviation of the OID 52 from the training data 24 (FIG. 4, blocks 102-104).

In some examples, the drift signal 56 comprises an anomaly score. In some examples, it may be desirable to define an anomaly score such that larger values represent greater anomalies. In an example where the sidecar learning model 22 is a GMM, the output of the GMM is a probability density strictly>0. In this example, reporting the negative logarithm of the probability density is one example of an anomaly score. If an incoming feature vector in the OID 52 falls outside of the region covered by the training data 24, the sidecar learning model 22 will yield a very small probability density, and hence a large value for the anomaly score. Such a large anomaly score indicates that the predictive output of the predictive learning model 20 may be considered suspect, regardless of whether or not any truth data is available for the data seen during operation. If the incoming OID 52 begins to show a trend of drift away from the original training data 24, the sidecar learning model 22 issues increasingly large anomaly scores. An operator may then respond by re-training a new predictive learning model, in some examples preferably before the performance of the predictive learning model 20 degrades far enough to impact its value.

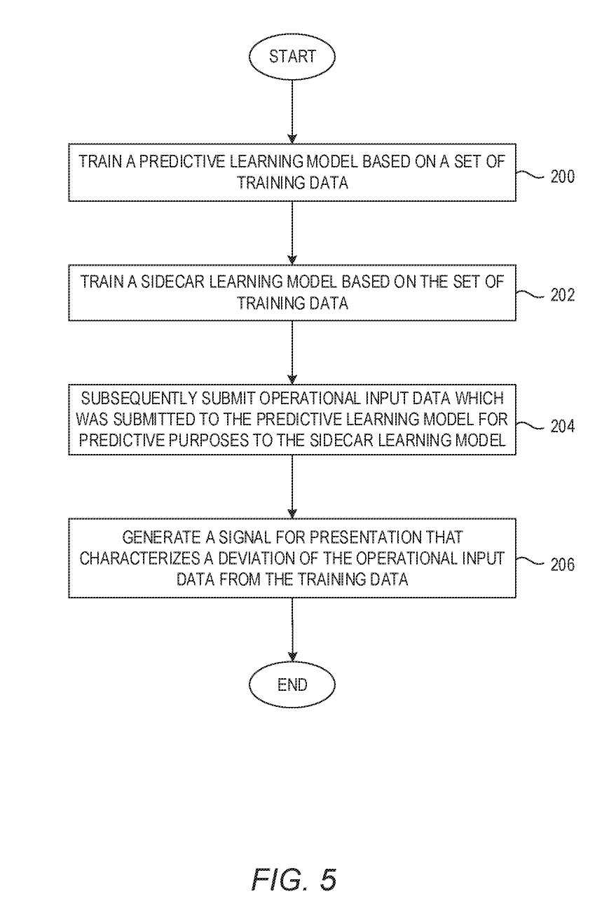

FIG. 5 is a flowchart of a method for generating a signal for presentation that characterizes a deviation of the operational input data 52 from the training data 24 according to one example. FIG. 5 will be discussed in conjunction with FIGS. 1 and 2. Initially the predictive learning model 20 is trained based on the set of training data 24 (FIG. 5, block 200). The sidecar learning model 22 is also trained based on the set of training data 24 (FIG. 5, block 202). The training of the predictive learning model 20 and the sidecar learning model 22 may be performed, for example, by the model trainor/creator 28, or by some other process.

Subsequently, the OID 52 that is submitted to the predictive learning model 20 for predictive purposes is submitted to the sidecar learning model 22 (FIG. 5, block 204). The sidecar learning model 22 generates a signal, such as the real-time graph 58, the confidence signal 64, or the alert 68, for presentation that characterizes a deviation of the OID 52 from the training data 24 (FIG. 5, block 206).

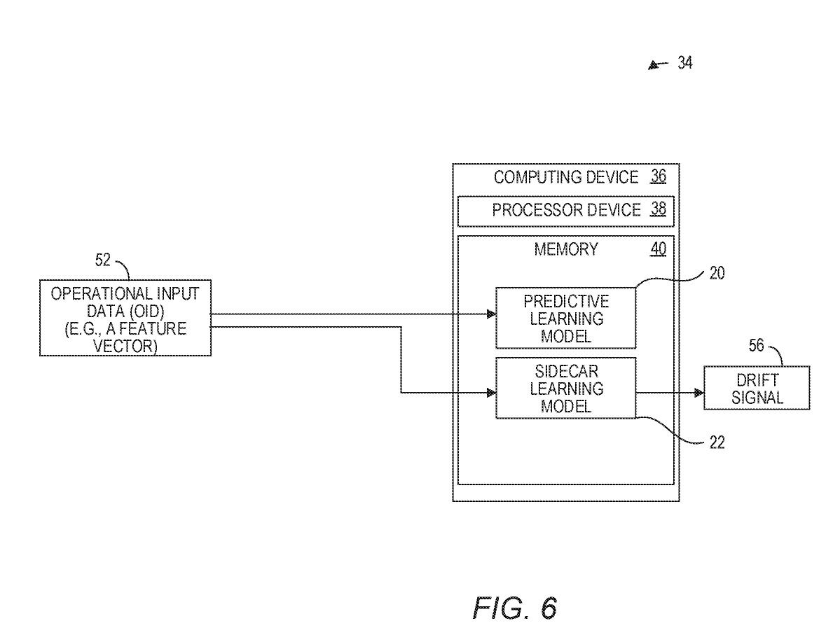

FIG. 6 is a simplified block diagram of the operational environment 34 illustrated in FIG. 2 according to one example. The operational environment 34 includes the computing device 36 which has the processor device 38 and the memory 40. The processor device 38 is coupled to the memory 40 and is to receive, by the sidecar learning model 22, the OID 52 submitted to the predictive learning model 20. The sidecar learning model 22 was trained on the same training data 24 used to train the predictive learning model 20. The sidecar learning model 22 determines a deviation of the OID 52 from the training data 24, and generates the drift signal 56 that characterizes the deviation of the OID 52 from the training data 24.

It is noted that because the sidecar learning model 22 is a component of the computing device 36, functionality implemented by the sidecar learning model 22 may be attributed to the computing device 36 generally. Moreover, in examples where the sidecar learning model 22 comprises software instructions that program the processor device 38 to carry out functionality discussed herein, functionality implemented by the sidecar learning model 22 may be attributed herein to the processor device 38.

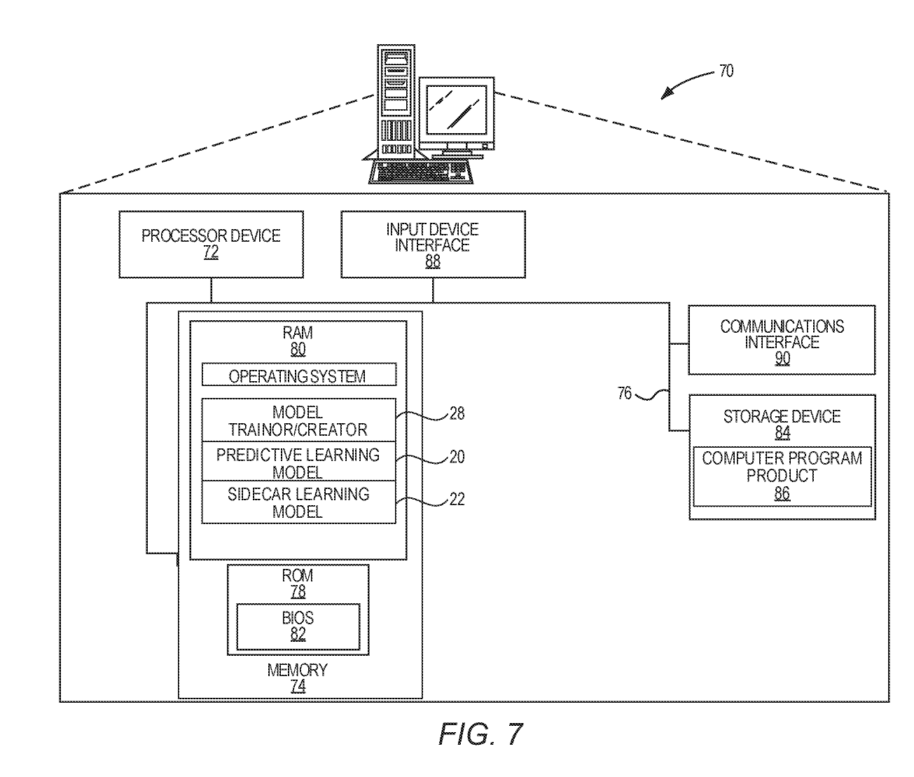

FIG. 7 is a block diagram of an example computing device 70 that is suitable for implementing examples according to one example. The computing device 70 is suitable for implementing the computing device 12 illustrated in

FIG. 1, and the computing device 36 illustrated in FIG. 2. The computing device 70 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 70 includes a processor device 72, a system memory 74, and a system bus 76. The system bus 76 provides an interface for system components including, but not limited to, the system memory 74 and the processor device 72. The processor device 72 can be any commercially available or proprietary processor.

The system bus 76 may be any of several types of bus structures that may further interconnect to a memory bus (with or without a memory controller), a peripheral bus, and/or a local bus using any of a variety of commercially available bus architectures. The system memory 74 may include non-volatile memory 78 (e.g., read-only memory (ROM), erasable programmable read-only memory (EPROM), electrically erasable programmable read-only memory (EEPROM), etc.), and volatile memory 80 (e.g., random-access memory (RAM)). A basic input/output system (BIOS) 82 may be stored in the non-volatile memory 78 and can include the basic routines that help to transfer information between elements within the computing device 70. The volatile memory 80 may also include a high-speed RAM, such as static RAM, for caching data.

The computing device 70 may further include or be coupled to a non-transitory computer-readable storage medium such as a storage device 84, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 84 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 84 and in the volatile memory 80, including an operating system and one or more program modules, such as the model trainor/creator 28, the predictive learning model 20, and/or the sidecar learning model 22, which may implement the functionality described herein in whole or in part.

A number of modules can be stored in the storage device 84 and in the volatile memory 80, including, by way of non-limiting example, the model trainor/creator 28, the predictive learning model 20, and/or the sidecar learning model 22. All or a portion of the examples may be implemented as a computer program product 86 stored on a transitory or non-transitory computer-usable or computer-readable storage medium, such as the storage device 84, which includes complex programming instructions, such as complex computer-readable program code, to cause the processor device 72 to carry out the steps described herein. Thus, the computer-readable program code can comprise software instructions for implementing the functionality of the examples described herein when executed on the processor device 72. The processor device 72, in conjunction with the model trainor/creator 28, the predictive learning model 20, and/or the sidecar learning model 22 in the volatile memory 80, may serve as a controller, or control system, for the computing device 70 that is to implement the functionality described herein.

A user may also be able to enter one or more configuration commands through a keyboard (not illustrated), a pointing device such as a mouse (not illustrated), or the like. Such input devices may be connected to the processor device 72 through an input device interface 88 that is coupled to the system bus 76 but can be connected by other interfaces such as a parallel port, an Institute of Electrical and Electronic Engineers (IEEE) 1394 serial port, a Universal Serial Bus (USB) port, an IR interface, and the like.

The computing device 70 may also include a communications interface 90 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a sidecar learning model, operational input data submitted to a predictive learning model, the sidecar learning model trained on a same training data used to train the predictive learning model;
determining a deviation of the operational input data from the training data; and
generating, by the sidecar learning model, a drift signal that characterizes the deviation of the operational input data from the training data.

2. The method of claim 1 further comprising:
receiving the training data;
modeling, by the sidecar learning model, a joint distribution of the training data; and
wherein determining the deviation of the operational input data from the training data comprises comparing the joint distribution of the training data to the operational input data.

3. The method of claim 2 wherein the sidecar learning model comprises one of a Gaussian mixture model, a self organizing map, an auto-encoding neural network, and a Mahalanobis-Taguchi system.

4. The method of claim 1 further comprising:
in response to the drift signal exceeding a predetermined threshold, retraining the predictive learning model.

5. The method of claim 1 further comprising automatically generating the sidecar learning model.

6. The method of claim 1 wherein generating the drift signal that characterizes the deviation of the operational input data from the training data further comprises generating an alert that indicates the operational input data deviates from the training data by a predetermined criteria.

7. The method of claim 1 further comprising generating a confidence signal that identifies a confidence level of the predictive learning model to the operational input data based on the drift signal.

8. The method of claim 1 further comprising presenting, in a user interface, a real-time graph that depicts the deviation of the operational input data from the training data.

9. A computing device, comprising:
a memory; and
a processor device coupled to the memory to:
receive, by a sidecar learning model, operational input data submitted to a predictive learning model, the sidecar learning model trained on a same training data used to train the predictive learning model;
determine a deviation of the operational input data from the training data; and
generate, by the sidecar learning model, a drift signal that characterizes the deviation of the operational input data from the training data.

10. The computing device of claim 9 wherein the processor device is further to:
receive the training data;
model, by the sidecar learning model, a joint distribution of the training data; and
wherein to determine the deviation of the operational input data from the training data, the processor device is further to compare the joint distribution of the training data to the operational input data.

11. The computing device of claim 9 wherein the processor device is further to:
in response to the drift signal exceeding a predetermined threshold, retrain the predictive learning model.

12. The computing device of claim 9 wherein the processor device is further to:
receive a request to train the predictive learning model; and
in response to the request, automatically generate the sidecar learning model.

13. The computing device of claim 9 wherein the processor device is further to generate a confidence signal that identifies a confidence level of the predictive learning model to the operational input data based on the drift signal.

14. The computing device of claim 9 wherein the processor device is further to present, in a user interface, a real-time graph that depicts the deviation of the operational input data from the training data.

15. A computer program product stored on a non-transitory computer-readable storage medium and including instructions to cause a processor device to:
receive, by a sidecar learning model, operational input data submitted to a predictive learning model, the sidecar learning model trained on a same training data used to train the predictive learning model;
determine a deviation of the operational input data from the training data; and
generate, by the sidecar learning model, a drift signal that characterizes the deviation of the operational input data from the training data.

16. The computer program product of claim 15 wherein the instructions further cause the processor device to:
receive the training data;
model, by the sidecar learning model, a joint distribution of the training data; and
wherein to determine the deviation of the operational input data from the training data, the processor device is further to compare the joint distribution of the training data to the operational input data.

17. The computer program product of claim 15 wherein the instructions further cause the processor device to:
in response to the drift signal exceeding a predetermined threshold, retrain the predictive learning model.

18. The computer program product of claim 15 wherein the processor device is further to:
receive a request to train the predictive learning model; and
in response to the request, automatically generate the sidecar learning model.

19. The computer program product of claim 15 wherein the processor device is further to generate a confidence signal that identifies a confidence level of the predictive learning model to the operational input data based on the drift signal.

20. The computer program product of claim 15 wherein the processor device is further to present, in a user interface, a real-time graph that depicts the deviation of the operational input data from the training data.
